(19) United States
(12) Patent Application Publication
(10) Pub. No.: US 2025/0003755 A1
(43) Pub. Date: Jan. 2, 2025

(54) METHOD AND APPARATUS FOR DETECTING UNMANNED AERIAL VEHICLE CONFLICT BASED ON AIRSPACE DIGITAL RASTER, AND STORAGE MEDIUM

(71) Applicant: NANJING UNIVERSITY OF AERONAUTICS AND ASTRONAUTICS, Nanjing (CN)

(72) Inventors: Hua XIE, Nanjing (CN); Yongwen ZHU, Nanjing (CN); Fangzheng SU, Nanjing (CN); Jianan YIN, Nanjing (CN); Ligang YUAN, Nanjing (CN); Lei YANG, Nanjing (CN); Zhao YANG, Nanjing (CN); Jie BAO, Nanjing (CN); Zhili TANG, Nanjing (CN); Changchun WANG, Nanjing (CN); Fan PU, Nanjing (CN)

(73) Assignee: NANJING UNIVERSITY OF AERONAUTICS AND ASTRONAUTICS, Nanjing (CN)

(21) Appl. No.: 18/278,650

(22) PCT Filed: Jul. 7, 2022
(86) PCT No.: PCT/CN2022/104396

§ 371 Date: May 17, 2024

(51) Int. Cl. G01C 21/22; G06F 30/20

(52) U.S. Cl. CPC G01C 21/22; G06F 30/20

(57) ABSTRACT

The present invention provides a method and an apparatus for detecting unmanned aerial vehicle conflict based on an airspace digital raster, and a storage medium, wherein the method comprises: establishing an airspace discrete subdivision raster model; constructing a conversion relationship between a raster code rule and longitude and latitude coordinates and grid codes; establishing an unmanned aerial vehicle safety protection area, and performing gridding expression on the unmanned aerial vehicle in the airspace; establishing a coordinate system to convert the grid codes of the unmanned aerial vehicle into coordinates; calculating the Minkowski difference set of two blocks using the GJK algorithm; and determining whether the unmanned aerial vehicle conflicts or not according to the Minkowski difference set. Through combining an airspace raster code and the GJK algorithm, compare with traditional coordinate operation in pairs, the present invention can effectively reduce the complexity of conflict detection, save a lot of calculation time, and effectively improve the efficiency of detecting unmanned aerial vehicle conflict to meet the rapid and real-time conflict detection requirements of unmanned aerial vehicles in the airspace.

### TECHNICAL FIELD

The present invention relates to the field of aviation, and in particular to a method and an apparatus for detecting unmanned aerial vehicle conflict based on an airspace digital raster, and a storage medium.

### BACKGROUND

In recent years, with the rapid increase in the number of unmanned aerial vehicles, research in the field of unmanned aerial vehicles has achieved unprecedented development. Compared with the traditional manned aircraft, the unmanned aerial vehicle has the advantages of low cost, high cost performance, convenience in use, high maneuverability, and the like due to man-machine separation. With the rapid increase in the number of unmanned aerial vehicles, the low-altitude airspace is gradually congested, and how to efficiently detect unmanned aerial vehicle conflicts in the low-altitude airspace is a key problem restricting the safe flight of the unmanned aerial vehicles.

The traditional conflict detection method can be used for conflict detection of the unmanned aerial vehicle operating in the low-altitude airspace, and whether a conflict exists or not is determined by calculating the distance between the positions of all track points. Under the condition that unmanned aerial vehicle tracks involve a large airspace range with the increase in the number of unmanned aerial vehicles, if a traditional conflict detection method is used, according to the operating characteristics and the volume of the unmanned aerial vehicles, the computation under longitude and latitude coordinates cannot reach high precision, the computation complexity is high, and the efficiency of conflict detection can be reduced. As a result, the computation time of the algorithm is too long, and even conflicts cannot be effectively detected, and the requirement of detecting unmanned aerial vehicle conflict cannot be met.

Airspace gridding refers to a discretization airspace method for establishing an airspace mesh unit subdivision method, constructing airspace system data analysis based on network index, and developing airspace performance related research by a rasterization method. The current research proves that the conflict detection efficiency can be greatly improved by a grid-based conflict detection algorithm, however, most research does not integrate the data information space of a gridding airspace and only adopts a gridding method through an application layer, and the proposed grid subdivision method does not perform modeling aiming at a specific operation environment.

Therefore, how to construct a low-altitude airspace-oriented environment and design grid codes to improve the conflict detection efficiency of the unmanned aerial vehicle is an urgent problem to be solved at present.

### SUMMARY

Objective: The technical problem to be solved in the present invention is, in view of the defects in the prior art, to provide a method for detecting unmanned aerial vehicle conflict based on an airspace digital raster, which comprises:
establishing an airspace discrete subdivision raster model;
constructing a conversion relationship between a raster code rule and longitude and latitude coordinates and grid codes;
establishing an unmanned aerial vehicle safety protection area, and performing gridding expression on the unmanned aerial vehicle in the airspace;
establishing a coordinate system to convert the grid codes of the unmanned aerial vehicle into coordinates;
calculating the Minkowski difference set of two blocks using the GJK (Gilbert-Johnson-Keerthi) distance algorithm; and
determining whether the unmanned aerial vehicle conflicts or not according to the Minkowski difference set.

Further, the establishing an airspace discrete subdivision raster model comprises the following steps:
step 1: expanding the latitude and longitude space of the earth three times, namely expanding a geographic space into 512° east-west and 512° north-south, expanding 1° to 64′, and expanding 1′ to 64″;
step 2: performing spherical recursive grid division based on the longitude and latitude of the geographic space, performing subdivision on a plane into three levels of degree, minute, and second level by level, dividing the earth spherical surface into 8-level recursive grids, and dividing into blocks with a minimum side length of 1′; and
step 3: performing altitude expression under conditions that the altitude is independent of spherical surface division, and can be divided into true altitude, surface pressure altitude, corrected sea level pressure altitude, and standard atmospheric pressure altitude according to different altitude reference surfaces, and performing upward expansion by taking X₁ (generally taking the value of 30 m) as granularity.

Further, the constructing a conversion relationship between a raster code rule and longitude and latitude coordinates and grid codes comprises:
dividing the code into a plane code and an altitude code, wherein the plane code and the altitude code all adopt a “Z”-shaped code, “degree”-level block code is represented by d, “minute”-level block code is represented by m, and “second”-level block code is represented by S, and combining the plane code and the altitude code to form the three-dimensional code of an airspace grid system.

Further, the establishing an unmanned aerial vehicle safety protection area comprises:
establishing the unmanned aerial vehicle safety protection area according to the operation performance of the unmanned aerial vehicle, wherein a horizontal interval and a longitudinal interval of the protection area is Dₕₒᵣ, and a vertical interval is Dᵥₑᵣ, and selecting a grid with proper granularity according to a size of the protection area. According to the classification standards of unmanned aerial vehicles, general civilian consumer unmanned aerial vehicles belong to micro unmanned aerial vehicles, corresponding to the 8th level grid granularity. The 6^{th} and 7^{th} level grids correspond to the sizes of medium and small unmanned aerial vehicles, respectively. Therefore, the 6^{th}, 7^{th}, and 8^{th} level grids can represent the vast majority of unmanned aerial vehicles. If some unmanned aerial vehicles have special sizes and cannot be directly represented by one grid, a plurality of grids can be used for combined expression.

Further, the method for performing gridding expression on the unmanned aerial vehicle in the airspace comprises:

wherein the gridding expression can express a target object through grid combination or independently; firstly, representing the unmanned aerial vehicle by only one cube, wherein Point represents cube information, and establishing the following point object expression model: Point=(θ, φ, h)=V_{laver=n,(θ,φ,h)},
wherein (θ, φ, h) represent the latitude, longitude and altitude of a location where the point object is located, respectively; V_{layer=n,(θ,φ,h)} represents a block with subdivision level of n at the latitude and longitude altitude; in the process of computer storage and operation, COde_{layer=n,(θ,φ,h)} represents a point object;
then using some continuous cubes to represent a path of the unmanned aerial vehicle, wherein Line represents a flight trajectory of the unmanned aerial vehicle, and establishing the following line object expression model:

Line=(θ,φ,h)=V_{layer=n,(θ,φ,h)},
wherein when the unmanned aerial vehicle or an obstacle object cannot be represented by one cube, more than two small grids that are stacked are used to represent an irregular-shaped object, Space represents an object formed by stacking more than two cubes, and the following body object expression model is established:

Space=(θ,ϕ,h)=V_{layer=n,(θ,φ,h).}

Aiming at the current unmanned aerial vehicle detection object, performing code conversion on the flight latitude and longitude and the altitude information acquired from an airborne ADS-B (ADS-B system is an abbreviation of automatic dependent surveillance-broadcast system) equipment or a ground station, wherein the formula is as follows:

$${Code}_{Lon} = \{ \begin{matrix}{Lon}_{d} / {gridsize}_{n} , & \begin{matrix}1 & n & 2\end{matrix} \\ ( \begin{matrix}{Lon}_{d} & 64 & {Lon}_{m}\end{matrix} ) / {gridsize}_{n} , & \begin{matrix}3 & n & 5\end{matrix} \\ ( \begin{matrix}{Lon}_{d} & 64 & 64 + {Lon}_{m} & 64 & {Lon}_{s}\end{matrix} ) / {gridsize}_{n} , & \begin{matrix}6 & n & 8\end{matrix}\end{matrix}$$

$${Code}_{Lat} = \{ \begin{matrix}{Lat}_{d} / {gridsize}_{n} , & \begin{matrix}1 & n & 2\end{matrix} \\ ( \begin{matrix}{Lat}_{d} & 64 & {Lat}_{m}\end{matrix} ) / {gridsize}_{n} , & \begin{matrix}3 & n & 5\end{matrix} \\ ( \begin{matrix}{Lat}_{d} & 64 & 64 + {Lat}_{m} & 64 & {Lat}_{s}\end{matrix} ) / {gridsize}_{n} , & \begin{matrix}6 & n & 8\end{matrix}\end{matrix}$$

$${Code}_{Alt} = Alt / {x}_{1}$$

wherein Code_{Lon}, Code_{Lat}, and Code_{Alt} represent longitude code, latitude code, and altitude code, respectively, n represents code level, gridsizeₙ represents a size of granularity of the grid at the n^{th} level, Lon_{d}, Lonₘ, and Lonₛ represent degree, minute, and second in longitude coordinates, respectively, and altitude level extends a separate code for the granularity according to x₁.

Further, the establishing a coordinate system to convert the grid codes of the unmanned aerial vehicle into coordinates comprises:
after gridding expression is performed on the unmanned aerial vehicle in the airspace, placing the unmanned aerial vehicle and a track point thereof in a grid coordinate system, and converting the longitude and latitude coordinates into Cartesian coordinate integer operation.

Further, the calculating the Minkowski difference set of two blocks using the GJK algorithm comprises:
calculating a distance between two convexities by using the GJK algorithm, wherein a distance between object A and object B is represented by d(A, B), and is expressed by the following formula:

$$d ( A , B ) = min \{ ‖ x - y ‖ : x A , y B \} ;$$

wherein x and y represent a point in the object A and a point in the object B, respectively, and the object A and the object B are all cubes;
two points a∈A and b∈B with the shortest distance between the object A and the object B meet ∥a−b∥=d(A, B);
the Minkowski difference set is a set of points formed by the difference between all points of the object A and all points of the object B, and is represented as follows:

$$M ( A , B ) = \{ x - y : x A , y B \} ;$$

M(A, B) represents the Minkowski difference set of cube A and cube B;
the distance between object A and object B is represented by the Minkowski difference set and is described as follows: d(A, B)=min∥M(A, B)∥=min {∥x−y∥: x A, y B}.

Further, the determining whether the unmanned aerial vehicle conflicts or not according to the Minkowski difference set comprises: converting a distance between unmanned aerial vehicles into a Minkowski difference between the unmanned aerial vehicles, and determining whether two objects collide or not by determining whether a difference set contains an origin point or not, wherein a distance between two unmanned aerial vehicles is greater, then the central point of difference set is farther away from the origin point, otherwise, the central point of difference set is closer to the origin point. If the unmanned aerial vehicle blocks collide, the difference set polygon will contain the origin point.

The present invention further provides an apparatus for detecting unmanned aerial vehicle conflict based on an airspace digital raster, which comprises:
an airspace discrete subdivision raster model establishment module configured to establish an airspace discrete subdivision raster model;
a conversion relationship construction module configured to construct a conversion relationship between a raster code rule and longitude and latitude coordinates and grid codes;
a gridding expression module configured to establish an unmanned aerial vehicle safety protection area, and perform gridding expression on the unmanned aerial vehicle in the airspace;
a coordinate conversion module configured to establish a coordinate system to convert the grid codes of the unmanned aerial vehicle into coordinates;
a Minkowski difference set calculation module configured to calculate the Minkowski difference set of two blocks using the GJK distance algorithm; and
an unmanned aerial vehicle conflict determination module configured to determine whether the unmanned aerial vehicle conflicts or not according to the Minkowski difference set.

The present invention further provides a storage medium, wherein the storage medium stores a computer program or instructions, and when the computer program or the instructions are executed, the method for detecting unmanned aerial vehicle conflict based on the airspace digital raster is implemented.

The present invention has the following beneficial effects: the present invention provides a method for detecting unmanned aerial vehicle conflict based on an airspace digital raster. The method for detecting unmanned aerial vehicle conflict based on the airspace digital raster comprises: establishing an airspace discrete subdivision raster model; constructing a conversion relationship between a raster code rule and longitude and latitude coordinates and grid codes; establishing an unmanned aerial vehicle safety protection area, and performing gridding expression on the unmanned aerial vehicle in the airspace; establishing a coordinate system to convert the grid codes of the unmanned aerial vehicle into coordinates; calculating the Minkowski difference set of two blocks using the GJK algorithm; and determining whether the unmanned aerial vehicle conflicts or not according to the Minkowski difference set. Through combining an airspace raster code and the GJK algorithm, compare with traditional coordinate operation in pairs, the present invention can effectively reduce the complexity of conflict detection, save a lot of calculation time, and effectively improve the efficiency of detecting unmanned aerial vehicle conflict to meet the rapid and real-time conflict detection requirements of unmanned aerial vehicles in the airspace.

### BRIEF DESCRIPTION OF THE DRAWINGS

The present invention will be further described in detail below in conjunction with the accompanying drawings and specific embodiments, and the advantages of the above and/or other aspects of the present invention will become more apparent.

FIG. 1 is a flowchart of a method for detecting unmanned aerial vehicle conflict based on an airspace digital raster according to the present invention.

FIG. 2 is a schematic diagram of grid expansion.

FIG. 3 is a schematic diagram of subdivision level division.

FIG. 4 is a schematic diagram of the Minkowski difference set distance conversion.

FIG. 5 is a schematic diagram of three unmanned aerial vehicles A, B, C of the same type represented as three 8^{th} level grid-sized cubes.

FIG. 6 is a schematic diagram of the Minkowski difference results of A and B.

FIG. 7 is a schematic diagram of the Minkowski difference results of A and C.

FIG. 8 shows the comparison of conflict detection time.

### DETAILED DESCRIPTION OF THE EMBODIMENTS

### Embodiment

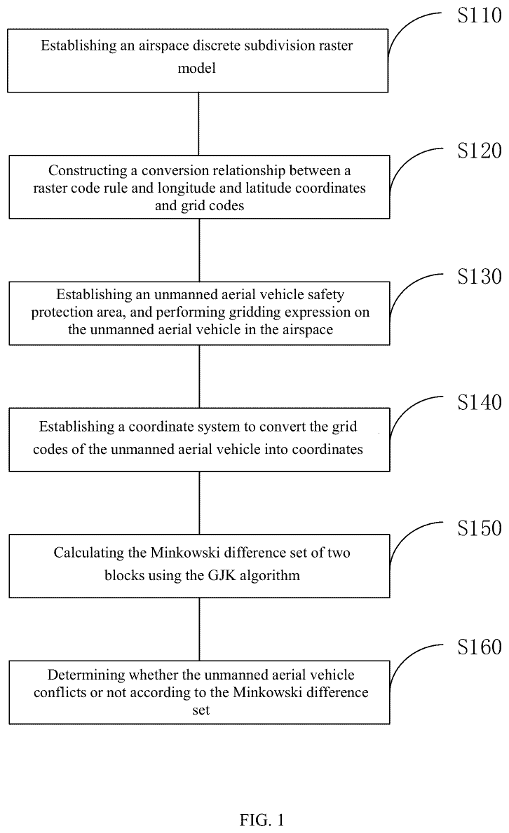

As shown in FIG. 1, the present invention provides a method for detecting unmanned aerial vehicle conflict based on an airspace digital raster. An air-traffic area division method based on the fuzzy C-means clustering comprises the following steps:
S110: establishing an airspace discrete subdivision raster model;
S120: constructing a conversion relationship between a raster code rule and longitude and latitude coordinates and grid codes;
S130: establishing an unmanned aerial vehicle safety protection area, and performing gridding expression on the unmanned aerial vehicle in the airspace;
S140: establishing a coordinate system to convert the grid codes of the unmanned aerial vehicle into coordinates;
S150: calculating the Minkowski difference set of two blocks using the GJK algorithm, and
S160: determining whether the unmanned aerial vehicle conflicts or not according to the Minkowski difference set.

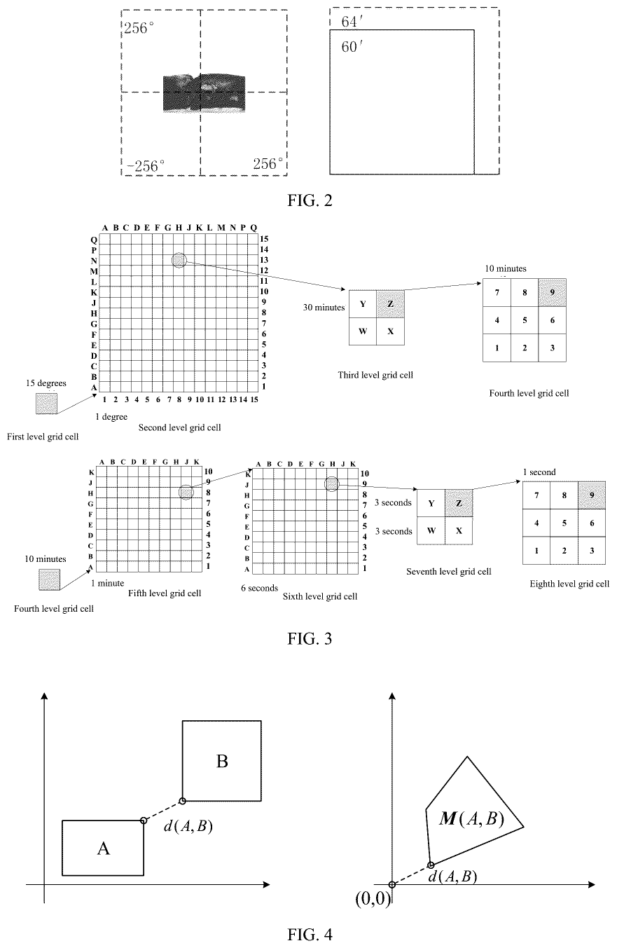

In this embodiment, step S110 comprises: performing spherical surface subdivision and altitude subdivision on the earth, performing recursive grid division, analyzing the requirement of an airspace gridding method according to the operation characteristics of a low-altitude airspace, constructing a discretized gridding airspace and establishing the grid subdivision of a digital model.
S111: expanding the latitude and longitude space of the earth three times, namely expanding a geographic space into 512° east-west and 512° north-south, expanding 1° to 64′, and expanding 1′ to 64″, as shown in FIG. 2;
S112: performing spherical recursive grid division based on the longitude and latitude of the geographic space, performing subdivision on a plane into three levels of degree, minute, and second level by level, dividing the earth spherical surface into 8-level recursive grids, and dividing into blocks with a minimum side length of 1′, as shown in Table 1; and
S113: performing altitude expression under conditions that the altitude is independent of spherical surface division, and can be divided into true altitude, surface pressure altitude, corrected sea level pressure altitude, and standard atmospheric pressure altitude according to different altitude reference surfaces, and performing upward expansion by taking 30 m as granularity.

In this embodiment, step S120 comprises the following steps: dividing the code into a plane code and an altitude code, wherein the plane code and the altitude code all adopt a “Z”-shaped code, “degree”-level block code is represented by d, “minute”-level block code is represented by m, and “second”-level block code is represented by s, and combining the plane code and the altitude code to form the three-dimensional code of an airspace grid system.

TABLE 1

| | | Approximate scale | |
|---|---|---|---|
| Subdivision level | Grid size | around the equator | |
| First level | 15° × 15° | 1669 | km |
| Second level | 1° × 1° | 111 | km |
| Third level | 30′ × 30′ | 56 | km |
| Fourth level | 10′ × 10′ | 9 | km |
| Fifth level | 1′ × 1′ | 1 | km |
| Sixth level | 6″ × 6″ | 0.2 | km |
| Seventh level | 3″ × 3″ | 0.1 | km |
| Eighth level | 1″ × 1″ | 0.03 | km |

In this embodiment, the step S130 comprises the following steps:
S131: Establishing the unmanned aerial vehicle safety protection area according to the operation performance of the unmanned aerial vehicle, wherein a horizontal interval and a longitudinal interval of the protection area is Dₕₒᵣ or, and a vertical interval is Dᵥₑᵣ, and selecting a grid with proper granularity according to a size of the protection area.
S132: Establishing a point object expression model:

Point=(θ,φ,h)=V_{laver=n,(θ,φ,h)},
wherein (θ, φ, h) represent the latitude, longitude and altitude of a location where the point object is located, respectively; V_{layer=n,(θ,φ,h)} represents a block with subdivision level of n at the latitude and longitude altitude, as shown in FIG. 3. According to the classification standards of unmanned aerial vehicles, general civilian consumer unmanned aerial vehicles belong to micro unmanned aerial vehicles, corresponding to the 8^{th} level grid granularity. The 6^{th} and 7^{th} level grids correspond to the sizes of medium and small unmanned aerial vehicles, respectively. Therefore, the 6^{th}, 7^{th}, and 8^{th} level grids can represent the vast majority of unmanned aerial vehicles. If some unmanned aerial vehicles have special sizes and cannot be directly represented by one grid, a plurality of grids can be used for combined expression.

In the process of computer storage and operation, Code_{layer=n,(θ,φ,h)} represents a point object;
S133: establishing a line object expression model:

Line=(θ,φ,h)=V_{layer=n,(θ,φ,h)};
S134: establishing a body object expression model:

Space=(θ,φ,h)=V_{layer=n,(θ,φ,h)}.

Aiming at the current unmanned aerial vehicle detection object, performing code conversion on the flight latitude and longitude and the altitude information acquired from an airborne ADS-B equipment or a ground station, wherein the formula is as follows:

$${Code}_{Lon} = \{ \begin{matrix}{Lon}_{d} / {gridsize}_{n} , & \begin{matrix}1 & n & 2\end{matrix} \\ ( \begin{matrix}{Lon}_{d} & 64 & {Lon}_{m}\end{matrix} ) / {gridsize}_{n} , & \begin{matrix}3 & n & 5\end{matrix} \\ ( \begin{matrix}{Lon}_{d} & 64 & 64 + {Lon}_{m} & 64 & {Lon}_{s}\end{matrix} ) / {gridsize}_{n} , & \begin{matrix}6 & n & 8\end{matrix}\end{matrix}$$

$${Code}_{Lat} = \{ \begin{matrix}{Lat}_{d} / {gridsize}_{n} , & \begin{matrix}1 & n & 2\end{matrix} \\ ( \begin{matrix}{Lat}_{d} & 64 & {Lat}_{m}\end{matrix} ) / {gridsize}_{n} , & \begin{matrix}3 & n & 5\end{matrix} \\ ( \begin{matrix}{Lat}_{d} & 64 & 64 + {Lat}_{m} & 64 & {Lat}_{s}\end{matrix} ) / {gridsize}_{n} , & \begin{matrix}6 & n & 8\end{matrix}\end{matrix}$$

$${Code}_{Alt} = Alt / {x}_{1}$$

wherein Code_{Lon}, Code_{Lat}, and Code_{Alt} represent longitude code, latitude code, and altitude code, respectively, n represents code level, gridsizeₙ represents a size of granularity of the grid at the n^{th} level, Lon_{d}, Lonₘ, and Lonₛ represent degree, minute, and second in longitude coordinates, respectively, and altitude level extends a separate code for the granularity according to x₁.

In this embodiment, the step S140 comprises: after the airspace is subjected to gridding expression, placing the unmanned aerial vehicle and a track point thereof in a grid coordinate system, and converting the longitude and latitude coordinates into Cartesian coordinate integer operation.

In this embodiment, the step S150 comprises:
S151: calculating a distance between two convexities by using the GJK algorithm, wherein a distance between object A and object B is represented by d(A, B), and is expressed by the following formula:

$$d ( A , B ) = min \{ ‖ x - y ‖ : x A , y B \}$$

two points a∈A and b∈B with the shortest distance between the object A and the object B meet ∥a−b∥=d(A, B);
S152: the Minkowski difference set is a set of points formed by the difference between all points of the object A and all points of the object B, and can be represented as follows:

$$M ( A , B ) = \{ x - y : x A , y B \} ;$$

S153: the distance between objects A and B can be represented by the Minkowski difference set, as shown in FIG. 4, and is described as follows:

$$d ( A , B ) = min ‖ M ( A , B ) ‖ = min \{ ‖ x - y ‖ : x A , y B \} .$$

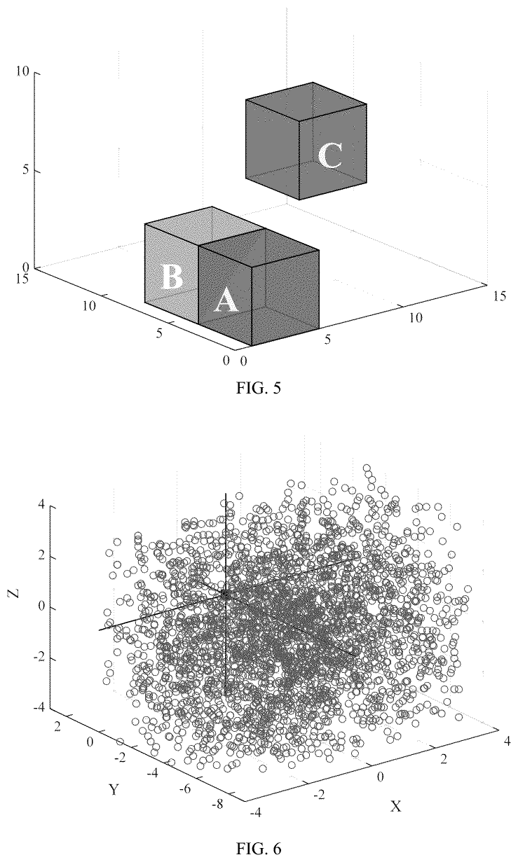

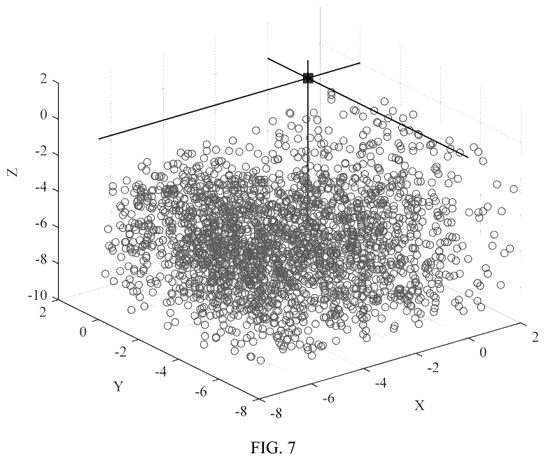

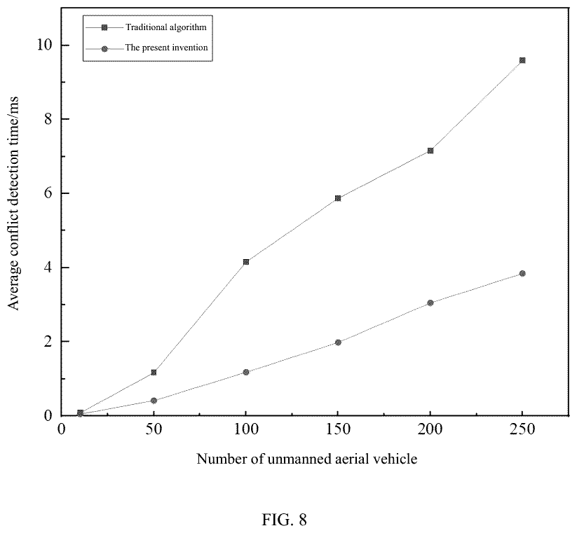

In this embodiment, the step S160 comprises: converting a distance between unmanned aerial vehicles into a Minkowski difference between the unmanned aerial vehicles, and determining whether two objects collide or not by determining whether a difference set contains an origin point or not, wherein a distance between two unmanned aerial vehicles is greater, then the central point of difference set is farther away from the origin point, otherwise, the central point of difference set is closer to the origin point. If the unmanned aerial vehicle blocks collide, the difference set polygon will contain the origin point. The unmanned aerial vehicles A and B collide if and only if the Minkowski difference set M(A, B) of the two cubes contains the origin point. Three unmanned aerial vehicles A, B, C of the same type are expressed as three 8^{th} level grid sized cubes, as shown in FIG. 5, wherein A is in contact with B, and C is far away from A and B; the number of algorithm iterations is set to 5000, so the resulting the Minkowski difference set contains 5000 points, these element points are displayed in coordinates, and the Minkowski difference results for A and B, and A and C are shown in FIGS. 6 and 7, which intuitively shows the relationship between the Minkowski difference set and the origin point. As shown in FIG. 6, the origin point is located inside the Minkowski difference set generated by cubes A and B, and the origin point is located inside the difference set, indicating that the two conflict; however, if there is no conflict between cubes A and C, the origin point is located outside the Minkowski difference set between A and C, as shown in FIG. 7. The conflict detection time of the method of the present invention is analyzed, three unmanned aerial vehicles with different sizes are used, the 6^{th}, 7^{th} and 8^{th} level grid granularity are used as the cube representation of the three unmanned aerial vehicles with different types, 20 unmanned aerial vehicles including 3 medium unmanned aerial vehicles, 3 small unmanned aerial vehicles and 14 micro unmanned aerial vehicles are selected in the experiment, the 8^{th} level code is also used to generate the 1 km 1 km 0.6 km gridding airspace environment for the experiment, the average conflict detection time of two algorithms in a period of time is recorded, and the result is shown in FIG. 8. With the increase in the number of the unmanned aerial vehicles, the conflict detection time of the Euclidean distance conflict detection method for calculating the distance between the unmanned aerial vehicles in pairs under the traditional three-dimensional coordinate system increases approximately exponentially, the conflict detection method based on GJK increases linearly with a low increase trend, which shows the high efficiency of the method.

This embodiment further provides an apparatus for detecting unmanned aerial vehicle conflict based on an airspace digital raster, which comprises:
an airspace discrete subdivision raster model establishment module configured to establish an airspace discrete subdivision raster model;
a conversion relationship construction module configured to construct a conversion relationship between a raster code rule and longitude and latitude coordinates and grid codes;
a gridding expression module configured to establish an unmanned aerial vehicle safety protection area, and perform gridding expression on the unmanned aerial vehicle in the airspace;
a coordinate conversion module configured to establish a coordinate system to convert the grid codes of the unmanned aerial vehicle into coordinates;
a Minkowski difference set calculation module configured to calculate the Minkowski difference set of two blocks using the GJK distance algorithm; and
an unmanned aerial vehicle conflict determination module configured to determine whether the unmanned aerial vehicle conflicts or not according to the Minkowski difference set.

This embodiment further provides a storage medium, wherein the storage medium stores a computer program or instructions, and when the computer program or the instructions are executed, the method for detecting unmanned aerial vehicle conflict based on the airspace digital raster is implemented.

As described above, the apparatus according to the embodiment of the present application may be implemented in various terminal devices, such as a server of a distributed computing system. In one example, the apparatus according to the embodiment of the present application may be integrated into the terminal device as a software module and/or a hardware module. For example, the apparatus may be a software module in an operating system of the terminal device, or may be an application developed for the terminal device; of course, the apparatus may also be one of many hardware modules of the terminal device.

Alternatively, in another example, the apparatus and the terminal device may be separate terminal devices, and the apparatus may be connected to the terminal device through a wired and/or wireless network and transmit the interaction information according to an agreed data format.

In summary, the present invention provides a method for detecting unmanned aerial vehicle conflict based on an airspace digital raster, which comprises: establishing an airspace discrete subdivision raster model; constructing a conversion relationship between a raster code rule and longitude and latitude coordinates and grid codes; establishing an unmanned aerial vehicle safety protection area, and performing gridding expression on the unmanned aerial vehicle in the airspace; establishing a coordinate system to convert the grid codes of the unmanned aerial vehicle into coordinates; calculating the Minkowski difference set of two blocks using the GJK algorithm; and determining whether the unmanned aerial vehicle conflicts or not according to the Minkowski difference set. Through combining an airspace raster code and the GJK algorithm, compare with traditional coordinate operation in pairs, the present invention can effectively reduce the complexity of conflict detection, save a lot of calculation time, and effectively improve the efficiency of detecting unmanned aerial vehicle conflict to meet the rapid and real-time conflict detection requirements of unmanned aerial vehicles in the airspace.

The present invention provides a method and an apparatus for detecting unmanned aerial vehicle conflict based on an airspace digital raster, and a storage medium, and the technical solution is specifically implemented in many methods and approaches. The above descriptions are only preferred examples of the present invention. It should be noted that those of ordinary skill in the art can also make several improvements and modifications without departing from the principle of the present invention, and such improvements and modifications shall fall within the protection scope of the present invention. All components not specified in this embodiment can be implemented by the prior art.

1. A method for detecting unmanned aerial vehicle conflict based on an airspace digital raster, comprising the following steps:
establishing an airspace discrete subdivision raster model;
constructing a conversion relationship between a raster code rule and longitude and latitude coordinates and grid codes;
establishing an unmanned aerial vehicle safety protection area, and performing gridding expression on the unmanned aerial vehicle in the airspace;
establishing a coordinate system to convert the grid codes of the unmanned aerial vehicle into coordinates;
calculating the Minkowski difference set of two blocks using the GJK distance algorithm; and
determining whether the unmanned aerial vehicle conflicts or not according to the Minkowski difference set.

2. The method according to claim 1, wherein the establishing an airspace discrete subdivision raster model comprises the following steps:
step 1: expanding the latitude and longitude space of the earth three times, namely expanding a geographic space into 512° east-west and 512° north-south, expanding 1° to 64′, and expanding 1′ to 64″;
step 2: performing spherical recursive grid division based on the longitude and latitude of the geographic space, performing subdivision on a plane into three levels of degree, minute, and second level by level, dividing the earth spherical surface into 8-level recursive grids, and dividing into blocks with a minimum side length of 1′; and
step 3: performing altitude expression according to different altitude reference surfaces with the altitude being independent of spherical surface division, and performing upward expansion by taking X₁ as granularity.

3. The method according to claim 2, wherein the constructing a conversion relationship between a raster code rule and longitude and latitude coordinates and grid codes comprises:
dividing the code into a plane code and an altitude code, wherein the plane code and the altitude code all adopt a Z-shaped code, degree-level block code is represented by d, minute-level block code is represented by m, and second-level block code is represented by s, and combining the plane code and the altitude code to form the three-dimensional code of an airspace grid system.

4. The method according to claim 3, wherein the establishing an unmanned aerial vehicle safety protection area comprises:
establishing the unmanned aerial vehicle safety protection area according to the operation performance of the unmanned aerial vehicle, wherein a horizontal interval and a longitudinal interval of the protection area is Dₕₒᵣ, and a vertical interval is Dᵥₑᵣ, and selecting a grid with proper granularity according to a size of the protection area.

5. The method according to claim 4, wherein the performing gridding expression on the unmanned aerial vehicle in the airspace comprises:
firstly, representing the unmanned aerial vehicle by only one cube, wherein Point represents cube information, and establishing the following point object expression model:
$$Point = ( θ , φ , h ) = {V}_{layer = n , ( θ , φ , h )} ;$$
wherein θ, φ, h represent the latitude, longitude and altitude of a location where the point object is located, respectively; V_{layer=n,(θ,φ,h)} represents a block with subdivision level of n at the latitude and longitude altitude where θ, φ, h is located; Code_{layer=n,(θ,φ,h)} represents the point object;
then using continuous cubes to represent a path of the unmanned aerial vehicle, wherein Line represents a flight trajectory of the unmanned aerial vehicle, and establishing the following line object expression model:
$$Line = ( θ , φ , h ) = {V}_{layer = n , ( θ , φ , h )} ;$$
wherein when the unmanned aerial vehicle or an obstacle object cannot be represented by one cube, more than two small grids that are stacked are used to represent an irregular-shaped object, Space represents an object formed by stacking more than two cubes, and the following body object expression model is established:
$$Space = ( θ , φ , h ) = {V}_{layer = n , ( θ , φ , h )}$$
aiming at the current unmanned aerial vehicle detection object, performing code conversion on the flight latitude and longitude and the altitude information acquired from an airborne ADS-B equipment or a ground station, wherein the formula is as follows:
$${Code}_{Lon} = \{ \begin{matrix}{Lon}_{d} / {gridsize}_{n} , & \begin{matrix}1 & n & 2\end{matrix} \\ ( \begin{matrix}{Lon}_{d} & 64 & {Lon}_{m}\end{matrix} ) / {gridsize}_{n} , & \begin{matrix}3 & n & 5\end{matrix} \\ ( \begin{matrix}{Lon}_{d} & 64 & 64 + {Lon}_{m} & 64 & {Lon}_{s}\end{matrix} ) / {gridsize}_{n} , & \begin{matrix}6 & n & 8\end{matrix}\end{matrix}$$
$${Code}_{Lat} = \{ \begin{matrix}{Lat}_{d} / {gridsize}_{n} , & \begin{matrix}1 & n & 2\end{matrix} \\ ( \begin{matrix}{Lat}_{d} & 64 & {Lat}_{m}\end{matrix} ) / {gridsize}_{n} , & \begin{matrix}3 & n & 5\end{matrix} \\ ( \begin{matrix}{Lat}_{d} & 64 & 64 + {Lat}_{m} & 64 & {Lat}_{s}\end{matrix} ) / {gridsize}_{n} , & \begin{matrix}6 & n & 8\end{matrix}\end{matrix}$$
$${Code}_{Alt} = Alt / {x}_{1}$$
wherein Code_{Lon}, Code_{Lat}, and Code_{Alt} represent longitude code, latitude code, and altitude code, respectively, n represents code level, gridsizeₙ represents a size of granularity of the grid at the n^{th} level, Lon_{d}, Lonₘ, and Lonₛ represent degree, minute, and second in longitude coordinates, respectively, and altitude level extends a separate code for the granularity according to x₁.

6. The method according to claim 5, wherein the establishing a coordinate system to convert the grid codes of the unmanned aerial vehicle into coordinates comprises: after gridding expression is performed on the unmanned aerial vehicle in the airspace, placing the unmanned aerial vehicle and a track point thereof in a grid coordinate system, and converting the longitude and latitude coordinates into Cartesian coordinate integer operation.

7. The method according to claim 6, wherein the calculating the Minkowski difference set of two blocks using the GJK algorithm comprises:
calculating a distance between two convexities by using the GJK algorithm, wherein a distance between object A and object B is represented by d(A, B), and is expressed by the following formula:
$$d ( A , B ) = min \{ ‖ x - y ‖ : x A , y B \} ;$$
wherein x and y represent a point in the object A and a point in the object B, respectively;
two points a∈A and b∈B with the shortest distance between the object A and the object B meet ∥a−b∥=d(A, B);
the Minkowski difference set is a set of points formed by the difference between all points of the object A and all points of the object B, and is represented as follows:
$$M ( A , B ) = \{ x - y : x A , y B \} ;$$
M(A, B) represents the Minkowski difference set of cube A and cube B;
the distance between object A and object B is represented by the Minkowski difference set and is described as follows:
$$d ( A , B ) = min ‖ M ( A , B ) ‖ = min \{ ‖ x - y ‖ : x A , y B \} .$$

8. The method according to claim 7, wherein the determining whether the unmanned aerial vehicle conflicts or not according to the Minkowski difference set comprises:
converting a distance between unmanned aerial vehicles into a Minkowski difference between the unmanned aerial vehicles, and determining whether two objects collide or not by determining whether a difference set contains an origin point or not.

9. An apparatus for detecting unmanned aerial vehicle conflict based on an airspace digital raster, comprising:
an airspace discrete subdivision raster model establishment module configured to establish an airspace discrete subdivision raster model;
a conversion relationship construction module configured to construct a conversion relationship between a raster code rule and longitude and latitude coordinates and grid codes;
a gridding expression module configured to establish an unmanned aerial vehicle safety protection area, and perform gridding expression on the unmanned aerial vehicle in the airspace;
a coordinate conversion module configured to establish a coordinate system to convert the grid codes of the unmanned aerial vehicle into coordinates;
a Minkowski difference set calculation module configured to calculate the Minkowski difference set of two blocks using the GJK distance algorithm; and
an unmanned aerial vehicle conflict determination module configured to determine whether the unmanned aerial vehicle conflicts or not according to the Minkowski difference set.

10. A storage medium, wherein the storage medium stores a computer program or instructions, and when the computer program or the instructions are executed, the method according to any one of claims 1 to 8 is implemented.
